(19) United States
(12) Patent Application Publication
(10) Pub. No.: US 2013/0159062 A1
(43) Pub. Date: Jun. 20, 2013

(54) PROCESS-DRIVEN COMPOSITE APPLICATION ARCHITECTURE

(71) Applicant: Volker Stiehl, Moehrendorf (DE)

(72) Inventor: Volker Stiehl, Moehrendorf (DE)

(73) Assignee: SAP AG, Walldorf (DE)

(21) Appl. No.: 13/326,070

(22) Filed: Dec. 14, 2011

(51) Int. Cl. G06Q 10/06

(52) U.S. Cl. 705/7.36

(57) ABSTRACT

The present disclosure describes methods, systems, and computer program products for providing a process-driven composite application architecture. One method includes identifying a business process for implementation in an information technology (IT) landscape and a service contract associated with the identified business process, where the service contract defining business functionality required for implementation in the IT landscape. At least one technical process for implementing the business functionality defined by the service contract is identified. The identified business process is implemented in the IT landscape, where the implementation includes implementing a connection between the identified business process and the identified at least one technical process. In some instances, the business process and the at least one technical process are modeled in business process model and notation (BPMN). The service contract can include a service contract interface and a functionality description of the business process.

### TECHNICAL FIELD

The present disclosure relates to software, computer systems, and computer-implemented methods for providing a process-driven composite application architecture.

### BACKGROUND

In a globalized world, enterprises face difficult challenges as changes are consistently made in information technology (IT) architectures and their related technologies. As a consequence, companies and other entities consistently adapt their businesses in shorter and shorter timeframes caused by consistent improvements in technology. If their technology is not updated, the functionality upon which various applications rely may become outdated, unresponsive, or invalid, causing issues in a system and applications based on a particular IT infrastructure implementation. The adoption of new processes, technologies, and tools can provide companies, businesses, and other service providers with a distinct advantage over their competition. Businesses implementing differentiating business processes should work to implement and realize the benefits of updated technologies and infrastructures in order to provide their customers with the most productive systems.

### SUMMARY

The present disclosure describes methods, systems, and computer program products for providing a process-driven composite application architecture. One method includes identifying a business process for implementation in an information technology (IT) landscape and a service contract associated with the identified business process, where the service contract defining business functionality required for implementation in the IT landscape. At least one technical process for implementing the business functionality defined by the service contract is identified. The identified business process is implemented in the IT landscape, where the implementation includes implementing a connection between the identified business process and the identified at least one technical process. In some instances, the business process and the at least one technical process are modeled in business process model and notation (BPMN). The service contract can include a service contract interface and a functionality description of the business process.

While generally described as computer implemented software embodied on non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment 100 for implementing various features of a system for providing a process-driven composite application architecture.

FIG. 2 is a flowchart of an example method for defining a process-driven composite application, and specifically, a single business process within the composite application.

FIG. 3 is a flowchart of an example method for implementing a particular business process through the operations of a SCIL system as described in the present application.

FIG. 4 is an example illustration of a generic system where a composite application is implemented in an example IT landscape through use of the SCIL system.

FIG. 5 illustrates an example implementation of a composite application implemented an example IT landscape.

### DETAILED DESCRIPTION

This disclosure generally relates to software, computer systems, and computer-implemented methods for providing and implementing a process-driven composite application architecture. Specifically, tools and methods are used to implement new business-related functionality into a business process, while using a service contract implementation layer within a particular architecture to implement one or more services for performing the actions required by the newly defined business processes. The present disclosure describes a solution consisting of three key pillars. First, a methodology is defined to derive artifacts for providing better business process architectures. Specifically, a top-down, or process-driven, approach is employed, where business processes are built first, with those business processes used to derive one or more related objects (e.g., data objects, business objects, etc.) that the business processes operate on when executed, as well as the user interfaces used to fulfill interactions with end users. Further, the process-driven approach allows developers and business users to identify a set of business functionality associated with the business process that is available prior to development and that is expected to be provided by existing systems, as well as a set of business functionality that is new and unique to the new business process, and that is to be developed and described by the new business process.

The second concept is an application architecture which separates business processes from technical processes, and assigns clear tasks to each of those two layers. The relationship between the business process layer and the technical process layer is defined by a service contract, where the service contract includes an interface for the operations to be performed and an expected business functionality defining the actions and functionality needed by the developed business process. In some instances, the data types being used within the developed business processes and service contract are the same, such that a canonical data type system is used throughout the internal operations of the business processes. The technical process layer within the architecture interfaces with the business process through an implementation of the service contract, where the technical process layer can implement the technical processes required as defined in the service contract, or alternatively or in combination, the technical process layer can identify one or more processes, services, or other operations performed by one or more backend systems that can be used to implement the expected business functionality of the service contract. The technical process layer can provide the communication layer between any such systems, and can allow the business process layer to send and receive any business process-related information to the appropriate systems. In doing so, the business process in the business process layer can be developed based on the business functionality of the business process or processes alone, as opposed to being concerned with the particular technical implementation within the IT landscape. The technical process layer is referred to herein as the service contract implementation layer (SCIL). Because the business process is IT landscape-independent, the business functionality defined therein can be implemented in any appropriate IT infrastructure or landscape with minimal revisions, allowing the SCIL to be responsible for identifying the appropriate business functionality (e.g., services, backend applications, etc.) and technical process for implementing the business process with the identified business functionality in a particular environment. In a third portion of the preferred solution, both the business processes and the technical processes can be implemented in business process model and notation (BPMN), providing a common and executable modeling language allowing for simple design of applications and intercommunications between layers.

The architecture and methodology can define certain rules to assist in providing a superior and flexible solution. For example, the interface of the service contract is meant to be lean, meaning it consists of only the fields which the business processes require for complete operations. In doing so, the SCIL can quickly and easily identify corresponding services and technical processes for implementing the functionality requested by the business process. Further, the data types within the business process should be independent of the data types of existing systems. In doing so, the business processes are prevented from being polluted by existing data types and can remove potential explicit dependencies on a particular systems or landscapes. The SCIL can itself provide the existing functionality internally or through its inherent association with the prior system. Regarding the specific structure of the present disclosure, business-related activities and services are provided within the business process layer, while technical-related activities and services are provided within the SCIL. This separation allows users and developers to define new business functionality, allowing focus on the functionality being developed, as opposed to the eventual implementation or implementations of that functionality. This can assist in ensuring a backend- or technically-independent design of the desired business process and its functionality. In the preferred implementation, all modifying calls (i.e., create, update, and delete) are executed asynchronously. Further, the solution provides significant benefit to existing systems, as the process-driven development is non-invasive to those systems. Specifically, no changes are necessary with regard to the existing functionality of the backend systems, as their functionality is consumed, without change, within the SCIL. Resulting applications following the described architecture therefore have a lifecycle independent from the involved backend systems.

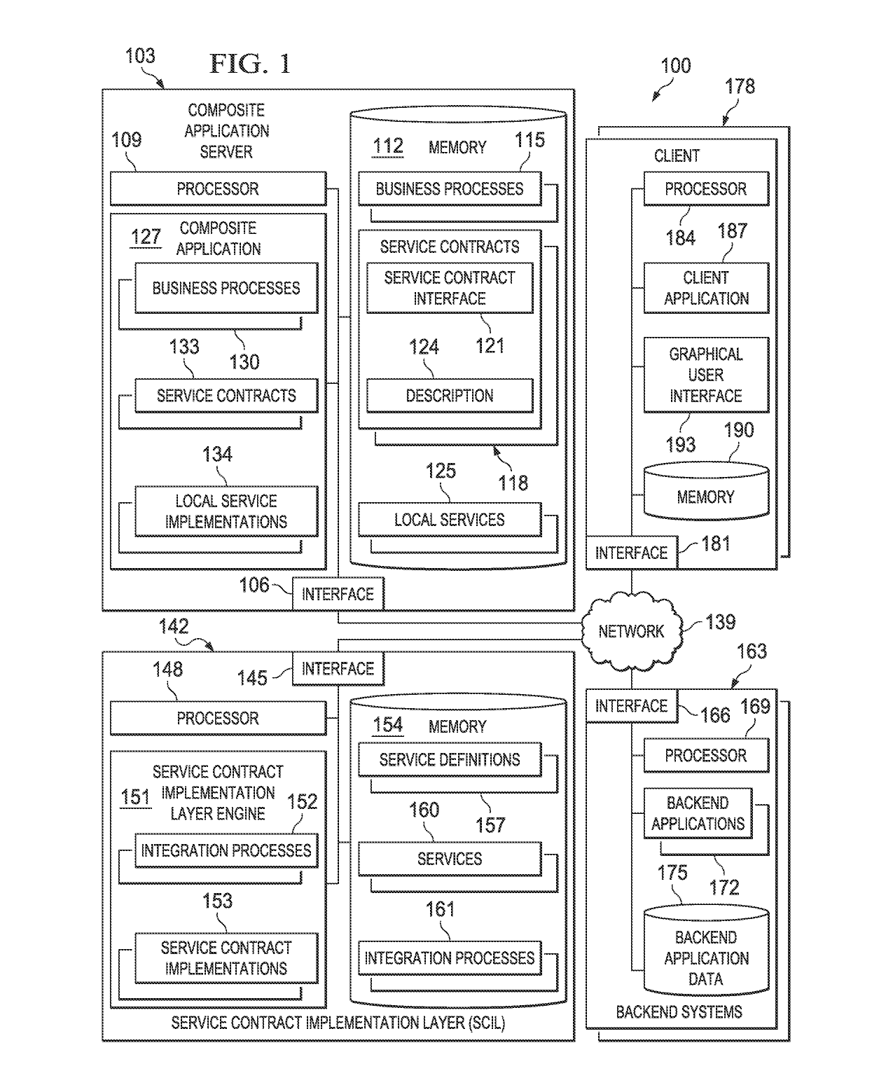

FIG. 1 illustrates an example environment 100 for implementing various features of a system for providing a process-driven composite application architecture. The illustrated environment 100 includes, or is communicably coupled with, a composite application server 103, a service contract implementation layer (SCIL) system 142, one or more backend systems 163, and one or more clients 178. At least some of the communication between the illustrated systems, including between the composite application server 103, the SCIL system 142, the backend systems 163, and the clients 178, may be performed across or via network 139. In general, environment 100 depicts an example configuration of a system for creating, maintaining, and enhancing process-driven application development and execution. One or more of the advantages described above may be realized by the environment 100, providing more process- and functionality-focused application development, using previously developed technical processes and available IT infrastructures to implement the business-related functionality. The illustrated composite application server 103 may be a system for creating, optimizing, modifying, and developing, among others, composite applications 127 focusing on the business-specific functionality of a particular entity. Composite applications can include a combination of one or more business processes 130. In some instances, each of the individual business processes 130 can be developed or created independently, with the functionality of multiple business processes 130 being combined into a corresponding composite application 127 at a later time. The different business processes 130 included in a single composite application 127 may be associated with their own interfaces and functionality, both described or provided by the corresponding service contract 133, and can share the information derived during their operations with the other business processes 130 included in the composite application 127. As further illustrated in FIG. 1, the SCIL system 142 includes an SCIL engine 151 and one or more integration processes 161 used to implement the service contracts 133 of the business processes 130 in the appropriate IT landscape in which the business processes 130 are to execute. In some instances, the SCIL system 142 and its SCIL engine 151 may identify particular services 160 to perform one or more technical operations required by the business processes 130, while in others, the SCIL engine 151 may use one or more integration processes 152 and other suitable techniques to implement the necessary business functionality associated with the corresponding business processes 130 to a backend system 163 and/or backend application 172 capable of performing the desired business functionality. The SCIL system 142 and/or its SCIL engine 151 can perform the required implementations of the backend functionality and provide the connections that allow for interactions between the business processes 130 and the backend applications 172. Each client 178 illustrated in FIG. 1 may represent a business, technical, or administrative user or sets of users interacting or working with one or more of the composite application server 103, the SCIL system 142, and/or one or more of the backend systems 163. Users at a particular client 178 may attempt to execute and perform tasks associated with the underlying business processes 130 and/or composite application 127, where appropriate. Additionally, a user at the particular client 178 may be an administrator authorized to modify one or more composite applications 127, business processes 130, or other information or settings associated with the composite application server 103 and its components, as well as the SCIL system 142. Environment 100 is an example, and in alternative implementations, the elements illustrated in FIG. 1 may be included in or associated with different and/or additional servers, clients, networks, and locations other than those as shown. For example, one or more of the components illustrated within the composite application server 103 may be located in multiple or different servers, cloud-based networks, or other locations accessible to the composite application server 103 (e.g., either directly or indirectly via network 139).

In general, the composite application server 103 is any server that stores and executes one or more composite applications 127. For example, the composite application server 103 may be a Java™ 2 Platform, Enterprise Edition (J2EE)®-compliant application server that includes Java™ technologies such as Enterprise JavaBeans® (EJB), J2EE® Connector Architecture (JCA), Java™ Messaging Service (JMS), Java™ Naming and Directory Interface (JNDI), and Java™ Database Connectivity (JDBC). In some instances, the composite application server 103 may store a plurality of various other applications (composite or otherwise), while in other instances, the composite application server 103 may be a dedicated server meant to store and execute a particular composite application 127 and its related functionality. In some instances, the composite application server 103 may comprise a web server or be communicably coupled with a web server, where one or more of the composite applications 127 associated with the composite application server 103 represent web-based (or web-accessible) applications accessed and executed through requests and interactions received on the client 178, executing a client application 187 operable to interact with the programmed tasks or operations of the corresponding composite application 127.

At a high level, the composite application server 103 comprises an electronic computing device operable to receive, transmit, process, store, or manage data and information associated with the environment 100. The composite application server 103 illustrated in FIG. 1 can be responsible for receiving application requests from one or more clients 178 (as well as any other entity or system interacting with the composite application server 103, including desktop or mobile client systems), responding to the received requests by processing said requests in the associated composite application 127 and its included business processes 130, and sending the appropriate responses from the composite application 127 back to the requesting client 178 or other requesting system. The composite application 127 can also process and respond to local requests from a user locally accessing the composite application server 103. Accordingly, in addition to requests from the clients 178 illustrated in FIG. 1, requests associated with a particular composite application 127 may also be sent from internal users, external or third-party customers, and other associated business applications or business processes, as well as any other appropriate entities, individuals, systems, or computers. The composite application server 103 may be in communication with the SCIL system 142, such that the particular implementations of one or more composite applications 127 (and the business processes 130 included therein) can be provided, where the SCIL system 142 identifies one or more services 160 and/or backend systems 163 and/or backend applications 172 to perform the business functionality (as implemented by the technical processes of the SCIL system 142) corresponding with the business processes 130 of composite application 127. In some instances, the composite application 127 may be a web-based application executing functionality associated with a networked or cloud-based business process. Still further, the composite application server 103 may respond to requests from clients 178 or other entities, including those accessing the composite application server 103 directly.

As used in the present disclosure, the term “computer” is intended to encompass any suitable processing device. For example, although FIG. 1 illustrates a single composite application server 103, environment 100 can be implemented using any number of composite application servers, as well as computers other than servers, including a server pool. Indeed, the composite application server 103 may be any computer or processing device such as, for example, a blade server, general-purpose personal computer (PC), Macintosh®, workstation, UNIX-based workstation, or any other suitable device. In other words, the present disclosure contemplates computers other than general purpose computers, as well as computers without conventional operating systems. Further, the illustrated composite application server 103 may be adapted to execute any operating system, including Linux, UNIX, Windows, Mac OS®, or any other suitable operating system.

In the illustrated implementation of FIG. 1, the composite application server 103 includes an interface 106, a processor 109, a memory 112, and a composite application 127. In some instances, the composite application server 103 and its illustrated components may be separated into multiple components executing at different servers and/or systems. Thus, while illustrated as a single component in the example environment 100 of FIG. 1, alternative implementations may illustrate the composite application server 103 as comprising multiple parts or portions accordingly.

FIG. 1 depicts a server-client environment, but could also represent a cloud-computing network based on particular deployment options. Various other implementations of the illustrated environment 100 can be provided to allow for increased flexibility in the underlying system, including multiple composite application servers 103 performing or executing one or more additional or alternative instances of the composite application 127 (for instance, in different IT landscapes), as well as other applications associated with or related to the composite application 127, including those illustrated as included as part of the composite application 127. In those instances, the different composite application servers 103 may communicate with each other via a cloud-based network or through the connections provided by network 139.

The interface 106 is used by the composite application server 103 to communicate with other systems in a client-server or other distributed environment (including within environment 100) connected to the network 139 (e.g., one of the clients 178, as well as other systems communicably coupled to the network 139). The interface 106 generally comprises logic encoded in software and/or hardware in a suitable combination and operable to communicate with the network 139. More specifically, the interface 106 may comprise software supporting one or more communication protocols associated with communications such that the network 139 or the interface's hardware is operable to communicate physical signals within and outside of the illustrated environment 100.

Generally, the composite application server 103 may be communicably coupled with a network 139 that facilitates wireless or wireline communications between the components of the environment 100 (i.e., between the composite application server 103, one or more clients 178, the SCIL system 142, and/or the one or more backend systems 163), as well as with any other local or remote computer, such as additional clients, servers, or other devices communicably coupled to network 139, including those not illustrated in FIG. 1. In the illustrated environment, the network 139 is depicted as a single network, but may be comprised of more than one network without departing from the scope of this disclosure, so long as at least a portion of the network 139 may facilitate communications between senders and recipients. In some instances, one or more of the components associated with the composite application server 103 may be included within the network 139 as one or more cloud-based services or operations.

The network 139 may be all or a portion of an enterprise or secured network, while in another instance, at least a portion of the network 139 may represent a connection to the Internet. In some instances, a portion of the network 139 may include a portion of a cellular or mobile data network or other network capable of relaying short message service (SMS) or multimedia messaging service (MMS) messages, as well as other suitable mobile data messaging. In some instances, a portion of the network 139 may be a virtual private network (VPN). Further, all or a portion of the network 139 can comprise either a wireline or wireless link. Example wireless links may include 802.11a/b/g/n, 802.20, WiMax, 3G, 4G (i.e., LTE), and/or any other appropriate wireless link. In other words, the network 139 encompasses any internal or external network, networks, sub-network, or combination thereof operable to facilitate communications between various computing components inside and outside the illustrated environment 100. The network 139 may communicate, for example, Internet Protocol (IP) packets, Frame Relay frames, Asynchronous Transfer Mode (ATM) cells, voice, video, data, and other suitable information between network addresses. The network 139 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the composite application server 103 includes a processor 109. Although illustrated as a single processor 109 in the composite application server 103, two or more processors may be used in the composite application server 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the composite application server 103 and, specifically, the functionality associated with the corresponding composite application 127, the various executing business processes 130, and/or one or more local services 125. In one implementation, the server's processor 109 executes the functionality required to receive and respond to requests and instructions from the client 178, functionality associated with communications between the composite application 127 and the SCIL system 142, as well as the functionality required to perform the operations of the associated composite application 127, business processes 130, and local service implementations 134, among others.

Regardless of the particular implementation, “software” may include computer-readable instructions, firmware, wired or programmed hardware, or any combination thereof on a non-transitory medium operable when executed to perform at least the processes and operations described herein. Indeed, each software component may be fully or partially written or described in any appropriate computer language including C, C++, Java™, Visual Basic, ABAP, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding composite application 127, business processes 130, and local service implementations 134 stored on the associated composite application server 103. In some instances, a particular composite application server 103 may be associated with the execution of two or more composite applications 127 (and other related components), as well as one or more distributed applications executing across two or more composite application servers 103.

At a high level, each composite application 127 is any application, program, module, process, or other software that may execute, change, delete, generate, or otherwise manage information associated with a particular composite application server 103, and in some cases, one or more business process processes performing and executing business process-related steps and events, where the business processes and their operations are designed and described in a process-driven manner. In some instances, the business processes 130 and/or the composite application 127 may be defined as business process models using an appropriate syntax or format, such as BPMN. The business process models can in some instances be executed directly at runtime, at which time a runtime compiler or other suitable component can interpret the models and execute the corresponding business processes 130 accordingly. In other instances, the business process models may be compiled into an appropriate process binary or other runtime format, allowing a runtime component to interpret and execute the compiled business processes.

In particular, business processes 130 communicate with other users, applications, systems, and components to send and receive events, while processing the data associated with these communications to perform one or more operations and tasks. Business process steps may be automated steps (e.g., calling a service) or an interactive step (e.g., calling a user interface and requesting user input). The composite application 127 is typically driven by user interfaces (UIs) executed with each business process 130 and the business process steps within each business process 130. In some instances, a particular composite application 127 can operate in response to and in connection with one or more requests received from an associated client 178 or other remote client. Additionally, a particular composite application 127 may operate in response to and in connection with one or more requests received from other business processes 130 outside of the composite application 127, as well as from other composite applications 127. In some instances, each composite application 127 may represent a web-based application accessed and executed by remote clients 178 via the network 139 (e.g., through the Internet, or via one or more cloud-based services associated with the composite application 127). Further, while illustrated as internal to the composite application server 103, one or more processes associated with a particular composite application 127 may be stored, referenced, or executed remotely. For example, a portion of a particular composite application 127 may be a web service that is remotely called, while another portion of the composite application 127 may be an interface object or agent bundled for processing at a remote system (not illustrated) or client 178 (e.g., the client application 187). Moreover, any or all of a particular composite application 127 may be a child or sub-module of another software module or enterprise application (not illustrated) without departing from the scope of this disclosure. Still further, portions of the particular composite application 127 may be executed or accessed by a user working directly at the composite application server 103, as well as remotely at a client 178.

The business processes 130 included in and performed by the composite application 127 in the present illustration can be business processes built by business experts, created independent of the existing IT and/or service landscape. In service-oriented architectures (SOA), new business processes are built to be dependent on particular services already available in the environment. When the environment changes in a SOA-based process, the implemented process may stop functioning correctly and/or as intended after the modification. Therefore, the business processes 130 described in the present implementation are top-down, or, restated, place the focus upon the process's corresponding business functionality, as opposed to its possible implementation environment or IT landscape.

For each business process 130 generated in this manner, a corresponding service contract 118, 133 is defined and/or derived. Business processes 130 may, in some instances, have two or more associated service contracts, as the business process 130 may require or request multiple sets of functionality. The service contract 118, 133 provides information associated with the corresponding business process 130, including a service contract interface (“SC interface”) 121 to external operations, services, and other entities, as well as a functionality description 124 for external users and systems to understand the functionality of the corresponding business process 130. In general, the SC interface 121 provides an essential interface to the business process 130, providing a specific and limited set of data elements and information that are provided by the business process 130 for external operations and services. The data elements provided by and associated with the SC interface 121 are limited to those essential to the external business functionality and technical processes to be associated with the business process 130 that are used to implement a particular instance of the business process 130 (or the composite application 127). In some instances, the SC interface 121 may be defined in a standard format, such as web services description language (WSDL). The functionality description 124 may be a natural language description of the expected functionality of the corresponding business process 130, as well as a description of one or more inputs and/or outputs required to successfully implement the business process 130. The SC interface 121 and functionality description 124 are identified, analyzed, and used by the SCIL system 142 to implement a concrete instance of the business process 130 (and its composite application 127), using the SCIL system's functionality to identify and associate appropriate technical processes and backend business functionality with the particular instance of the business process 130. Using this methodology, the development of business processes 130 is made IT landscape-independent, as the functionality of the various business processes 130 is created without reference to a particular implementation. Each service contract 118 is implemented within the SCIL system 142, and specifically, within the SCIL engine 151. In particular, the interface defined by the interface 121 is implemented by, and in some instances, within, the SCIL system 142, meeting the requirements and functionality defined by the service contract 118 (as illustrated by service contract implementations 153).

As illustrated, the composite application 127 includes one or more local service implementations 134, based on implementations of one or more local services 125 available at the composite application server 127. The local services 125 may be used or created when the particular IT landscape does not have or include the services necessary to perform one or more operations or functionality required by a composite application 127. In some instances, these local services 125 cannot be reused within the particular IT landscape, and are therefore implemented as part of the composite application. In some instances, these local service implementations 134 can be consumed similar to the integration processes 152, 161 of the SCIL system 142.

Memory 112 of the composite application server 103 stores data and program instructions. Memory 112 may include any memory or database module and may take the form of volatile or non-volatile memory including, without limitation, magnetic media, optical media, random access memory (RAM), read-only memory (ROM), removable media, or any other suitable local or remote memory component. Memory 112 may store various objects or data, including classes, frameworks, applications, backup data, business objects, jobs, web pages, web page templates, database tables, processes, process contexts, repositories storing services local to the composite application server 103, and any other appropriate information including any parameters, variables, algorithms, instructions, rules, constraints, or references thereto associated with the purposes of the composite application server 103 and the composite application(s) 127. In some implementations, including a cloud-based system, some or all of memory 112 may be stored remotely from the composite application server 103, and communicably coupled to the composite application server 103 (i.e., via network 139). As illustrated, memory 112 includes a set of business processes 115, the one or more service contracts 118 associated with each of the business processes 115, and the set of local services 125.

The set of business processes 115 is the set of stored business processes defined within or associated with the composite application server 103 for use in one or more composite applications 127. In some instances, business processes 115 can be shared between different systems, such as when various IT infrastructures and/or landscapes execute different instances of the same business processes 115. In some instances, the business processes 115 can be created in a different system and imported into memory 112, as appropriate.

The SCIL system 142 comprises an electronic computing device operable to receive, transmit, process, store, or manage data and information associated with the environment 100, and specifically, for implementing the service contracts 133 associated with the one or more business processes 130 included in a particular composite application 127. The SCIL system 142 is used when a composite application 127 is implemented in a particular IT landscape or environment, and assists the composite application 127 in identifying particular integration processes 152 and backend applications 172 or other services that fulfill the functionality description 124 of the involved business processes 130, while also fulfilling the data element requirements and instances of the SC interfaces 121 of those business processes 130. To perform these operations, the SCIL system 142 includes an interface 145, a processor 148, an SCIL engine 151, and a memory 154.

The interface 145 and the processor 148 may be similar or different than the interface 106 and processor 109 of the composite application server 103. The interface 145 generally allows the SCIL system 142 to communicate with network 139 and/or the other external systems. The processor 148 generally executes the SCIL engine 151 and other functionality and/or components associated with or included within the SCIL system 142.

The SCIL engine 151 performs operations associated with identifying the particular service contracts 133 associated with the composite application 127 and its business processes 130, identifying the appropriate local integration processes 152 and/or backend applications 172 (or other services) to associate with those business processes 130 based on the business processes' SC interfaces 121 and functionality descriptions 124, interconnecting the integration processes 152 and/or backend applications 172 to the composite application 127 and the business processes 130, and assisting in the communication between those components during execution. Each IT landscape or environment implementing instances of the composite application 127 can have its own SCIL system 142 using its own SCIL engine 151 to perform these operations, allowing the composite applications 127 to be easily installed and executed in different environments. When a connection between the appropriate local integration processes 152, other services, or backend applications 172 is implemented within the SCIL engine 151, the service contract may be considered to be implemented when the functionality requested by the business process 130 is provided. A set of implemented service interfaces 153 is illustrated within the SCIL engine 151, where those service interface implementations 153 represent the one or more concrete implementations of the service contracts 118 associated with the business processes 130 and/or composite application(s) 127 implemented in the present environment. Each service contract 118 associated with a particular business process 130 may be associated with a corresponding service contract implementation 153. The service contract implementations 153 may perform or facilitate the addition of business functionality to the corresponding business processes 130 and composite application 127, and can be implemented with assistance from one or more integration processes 152, where appropriate.

Memory 154 of the SCIL system 142 can be similar to or different from memory 112 of the composite application server 103, and can store or reference one or more service definitions 157, services 160, and integration processes 161, in addition to other various objects or data, including classes, frameworks, applications, backup data, business objects, jobs, web pages, web page templates, database tables, processes, process contexts, repositories storing services local to the SCIL system 142, and any other appropriate information including any parameters, variables, algorithms, instructions, rules, constraints, or references thereto associated with the purposes of the SCIL system 142 and/or the SCIL engine 151. The one or more service definitions 157 may comprise an index of available services and their locations, as well as information on how to implement those services. In some instances, at least a portion of the one or more service definitions 157 may include an index identifying available web or cloud-based services and/or backend applications 172 and their available functionality. These service definitions 157 can be interpreted by the SCIL engine 151 to identify the particular services or applications capable of implementing the functionality and operations required by the composite application 127. The services 160 may include one or more services that may be local to the SCIL system 142 identified with the service definitions 157. For instance, a local service 160 to the SCIL engine 151 may include a service storing the cross-reference numbers for connecting business objects in the composite application 127 with objects in one or more backend systems 163. This service is not considered an integration process 161, instead performing operations related to the service contract implementation and its functionality.

The integration processes 161 can include one or more technical processes included within the SCIL system 142 that can be used by the SCIL engine 151 to implement the business functionality of various business processes 130 within the composite application 127 with the technical processes needed to carry out or perform that business functionality. The integration processes 161 can each interact with particular data elements and information, such as the output or other data elements provided by particular business processes 130, and perform additional technical operations on those data elements prior to providing the modified data elements and information back to the business process 130. In some instances, an integration process may receive output from a particular business process step and return a corresponding set of information back to a different business process step, allowing the composite application 127 to perform its particular operations. One or more implemented integration processes 152 can be implemented in and executed by the SCIL engine 151 to perform the technical operations associated with the corresponding business processes 130. In some instances, the implemented integration processes 152 can perform the technical operations associated with the business process(es) 130 themselves, while in other instances, the implemented integration processes 152 may be associated with one or more additional integration processes 152, or alternatively, one or more backend applications 172 or other services capable of providing the required business functionality. In some instances, the technical processes associated with a particular business process 130 may not be available in a single integration process 152 or other service or application, requiring two or more integration processes 152, services, or backend applications 172 to perform together to provide the appropriate functionality. The SCIL engine 151 can perform the operations of combining or associating those operations to allow the business functionality to be performed by the plurality of components.

Environment 100 further includes one or more backend system 163. Each backend system 163 may be comprised of one or more servers, cloud-based systems, or other network-accessible locations that can provide business functionality and information that can be included in or reused by an implementation of one or more business processes 130 within the composite application 127. The backend systems 163 may be associated with web services, including REST-compliant services, as well as other suitable applications or operations. The illustrated backend systems 163 include an interface 166, processor 169, one or more backend applications 172, and backend application data 175 stored in memory. The interface 166 allows the backend systems 163 to communicate with network 139, and the processor 169 executes the backend applications 172 and other functionality associated with the particular backend system 163. The interface 166 and processor 169 may be implemented similar to or different from the interfaces and processors of the composite application server 103 and/or SCIL system 142. Each backend application 172 can be associated with different types of functionality, including functionality provided legacy systems, enterprise systems, and/or other suitable systems. In some instances, the backend applications 172 and backend systems 163 may be systems running related applications to the composite application server 103, such as a single company or entity's enterprise business applications. In other instances, the backend applications 172 and backend systems 163 may be a legacy system providing functionality unavailable to the updated systems associated with the composite application server 103. In still other instances, the backend applications 172 and backend systems 163 may be associated with third-party systems and applications, including business partners of the entity associated with the composite application server 103, allowing external operations and functionality to be used by the composite application 127 via the SCIL system 142. As such, functionality is consumed from the backend systems 163 as it is provided in a non-invasive manner. In other words, no enhancements or modifications are made to the backend systems 163 when reusing their preexisting business functionality.

The illustrated environment 100 includes one or more clients 178. The clients 178 may be associated with a particular composite application server 103, SCIL system 142, or backend system 163, or the clients 178 may generally execute in environment 100, capable of interacting with the one or more of those entities. Each client 178 may be any computing device operable to connect to or communicate with at least one of the aforementioned components using a wireline or wireless connection, via the network 139, or another suitable communication means or channel. In some instances, the client 178 may be a part of or associated with a business process involving one or more of the business processes 130 and/or composite applications 127.

In general, each client 178 includes a processor 184, an interface 181, a client application 187, a graphical user interface (GUI) 193, and a memory 190. In general, the client 178 comprises an electronic computer device operable to receive, transmit, process, and store any appropriate data associated with the environment 100 of FIG. 1. It will be understood that there may be any number of clients 178 associated with, or external to, environment 100. For example, while illustrated environment 100 includes a single client 178, alternative implementations of environment 100 may include multiple clients 178 communicably coupled to the one or more of the systems illustrated. In some instances, one or more clients 178 may be associated with administrators of the environment, and may be capable of accessing and interacting with the settings and operations of the composite application server 103, the composite application 127, one or more business processes 130, the SCIL system 142 and its associated components, and/or one or more of the backend systems 163 and their associated backend applications 172 and the related backend application data 175, and/or other components within the environment 100. Additionally, there may also be one or more additional clients 178 external to the illustrated portion of environment 100 capable of interacting with the environment 100 via the network 139. Further, the terms “client” and “user” may be used interchangeably as appropriate without departing from the scope of this disclosure. Moreover, while each client 178 is described in terms of being used by a single user, this disclosure contemplates that many users may use one computer, or that one user may use multiple computers.

The GUI 193 associated with each client 178 may comprise a graphical user interface operable to, for example, allow the user of a client 178 to interface with at least a portion of the composite application 127 and/or the business processes 130, and their associated operations and functionality. Generally, the GUI 193 provides the particular user with an efficient and user-friendly presentation of business data provided by or communicated within the system. The GUI 193 may comprise a plurality of customizable frames or views having interactive fields, pull-down lists, and buttons operated by the user. For example, the GUI 193 may provide interactive elements that allow a user to interact with a particular composite application 127 or business process 130, as well as other components within and/or external to environment 100. The different portions of the composite application server's functionality may be presented and accessible to the user through the GUI 193, such as through a client application 187 (in some instances, a web browser). Generally, the GUI 193 may also provide general interactive elements that allow a user to access and utilize various services and functions of a particular composite application 127. In some instances, the client application 187 may be used to access various portions of different composite application servers 103 or composite applications 127. In some instances, the client application 187 may be used to access (and the GUI 193 used to view) information retrieved from the memory 112 (i.e., a stored business process 115 and/or the corresponding service contract 118) via the composite application 127 and/or a dedicated process development module or product (not illustrated). Alternatively, the client application 187 may be used to access and manipulate the settings associated with the SCIL system 142 for determining rules and guidelines for implementing particular processes. In some instances, the client application 187 may be an agent or client-side version of the composite application 127. Alternatively, the client application 187 may be used to interact with user input-related tasks associated with the composite application 127 and/or particular business processes 130. The GUI 193 may present the information of the client application 187 for viewing and interaction. In general, the GUI 193 is often configurable, supports a combination of tables and graphs (bar, line, pie, status dials, etc.), and is able to build real-time portals, where tabs are delineated by key characteristics (e.g., site or micro-site). Therefore, the GUI 193 contemplates any suitable graphical user interface, such as a combination of a generic web browser, intelligent engine, and command line interface (CLI) that processes information in the platform and efficiently presents the results to the user visually.

As used in this disclosure, each client 178 is intended to encompass a personal computer, touch screen terminal, workstation, network computer, kiosk, wireless data port, smart phone, personal data assistant (PDA), one or more processors within these or other devices, or any other suitable processing device. For example, each client 178 may comprise a computer that includes an input device, such as a keypad, touch screen, mouse, or other device that can accept user information, and an output device that conveys information associated with the operation of one or more composite application servers 103 and their functionality and/or the client 178 itself, including digital data, visual information, or the GUI. Both the input and output device may include fixed or removable storage media such as a magnetic storage media, CD-ROM, or other suitable media, to both receive input from and provide output to users of client 178 through the display, namely, the GUI 193. The client's processor 184, interface 181, and memory 190 may be similar to or different from those described in connection with the other components illustrated in FIG. 1, although alternative implementations of one or more of these components may be used, as well as implementations where additional components may also be included. Generally, each system may be associated with one or more GUIs (not illustrated), such that users local to the composite application server 103, the SCIL system 142, and/or the backend system(s) 163, can access the functionality of the local component, as well as the remote functionality of the other illustrated components via network 139.

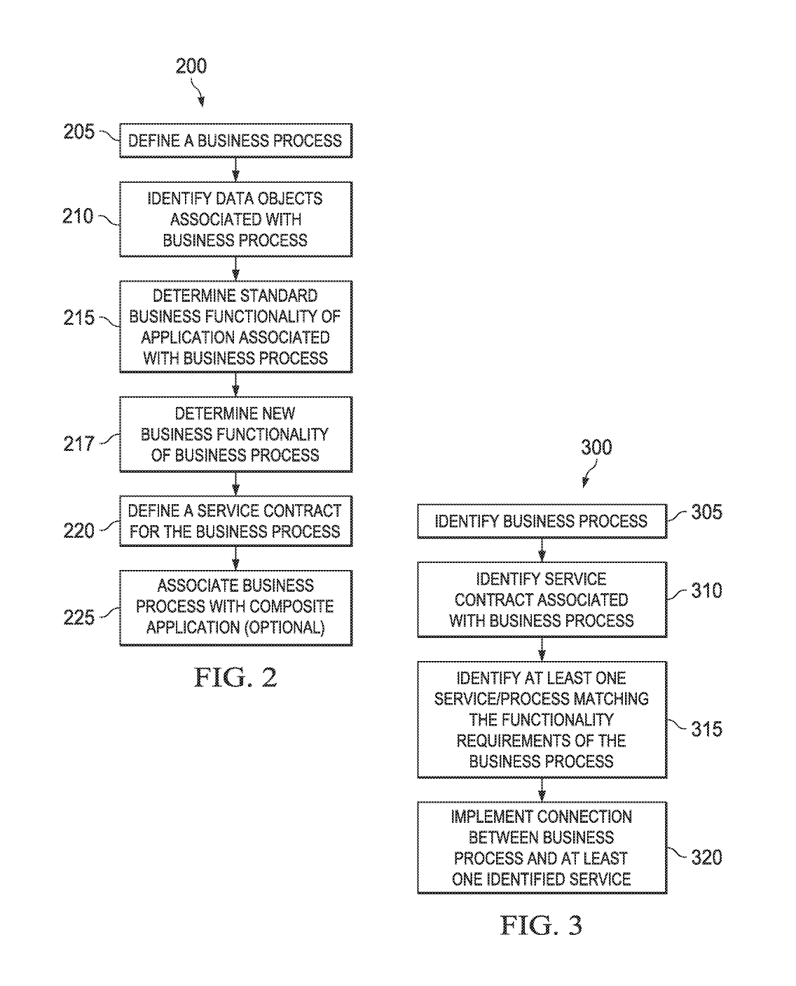

FIG. 2 is a flowchart of an example method 200 for defining a process-driven composite application, and specifically, a single business process within the composite application. For clarity of presentation, the description that follows generally describes method 200 in the context of environment 100 illustrated in FIG. 1. However, it will be understood that method 200 may be performed, for example, by any other suitable system, environment, or combination of systems and environments, as appropriate.

At 205, a business process is defined. In the present disclosure, defining the business process is performed independently of a particular IT landscape or environment, allowing the business process to be defined by its business functionality alone. In many instances, the business process may comprise a collection of business process steps combining, in sequence or parallel, to perform a business-related set of operations. The business process can be defined and developed using a standard modeling format, such as BPMN, or other suitable formats. In some instances, the modeled business process may be executable in its modeled state, while in others, the modeled business process may need to be compiled into an executable format prior to execution. As the business process is defined independent of the IT landscape, the technical processes for performing some of the business functionality associated with the business process will not be defined in this operation. Instead, once the business process is fully defined and ready to be implemented, a corresponding SCIL system or engine in a particular IT landscape can identify the technical and integration processes needed to fully implement the business process. It will also be understood that two or more business processes can be combined, once defined, to create a composite application, such as the composite application 127 described in FIG. 1.

At 210, data objects associated with the business process are identified. In some instances, the data objects may comprise business objects, user interfaces, or other suitable data objects. Generally, business processes affect some data object as its operations are performed, with the operations modifying the fields or attributes of the corresponding data object, and/or using the information within a particular instance of the data object to function. If a particular business process is associated with software licenses, for instance, a data object named “license” can be modeled or identified in a set of previously modeled data objects which encapsulates fields such as “softwareName,” “vendor,” “majorVersionNumber,” “minorVersionNumber,” “releaseDate,” and other suitable fields. In some implementations, the data object named “license” can be a business object, where the business object encapsulates fields, attributes, and methods, among others. The identified data objects can be included in and/or associated with the defined business process, incorporating the data object into the steps of the business process. The data types of the data and business objects can use a canonical data format independent of any particular IT landscape. Further, only fields relevant to the business process may be associated with the data object in some instances, allowing the business process's corresponding service contract to be defined in as lean an implementation as possible

At 215, a set of standard business functionality available to the business process may be determined. The standard functionality can include functionality available within a standard software product, such as an ERP or CRM system associated with the composite application or business process, as well as other available backend applications. An attempt to reuse as much standard functionality as possible allows developers to avoid repetitive developments. In some instances, a technical consultant or application expert can determine if some or all of the defined business processes or business process steps are available as inherent functionality to the associated application or software. Where the functionality overlaps, or where simple APIs or other interfaces are available to access the functionality, such functionality can be explicitly defined within the business process, as appropriate. The determined standard functionality generally will not be included within the business process being defined. Instead, that standard functionality can be identified, allowing the SCIL to implement that functionality when implementing the corresponding service contract. In some instances, the SCIL system may perform a similar determination at implementation, connecting the business process to one or more available sets of business functionality and technical processes.

At 217, the new business functionality to be provided by the business process is determined. The new business functionality may include the functionality that is not previously available from one or more backend applications or known services, and which can represent at least a portion of the differentiating business functionality provided by an implementation of the business process. This new functionality can be implemented as part of the composite application or business process in the form of a local service implementation (e.g., the local service implementation 134 illustrated in FIG. 1).

At least one service contract for the defined business process is defined at 220. Multiple service contracts can be defined for each business process, where appropriate. Whether more than one service contract should be defined for a particular business process can depend on the business functionality that the business process requests from the external systems connected via a corresponding SCIL system. The service contract for each business process, as described in FIG. 1, can include an interface defining the data elements associated with one or more steps within the business process, a functionality description providing information on the operations performed by the business process, and the desired business functionality to be associated with the business process at implementation. The desired business functionality can be fulfilled by the SCIL system using one or more technical processes. In some instances, the functionality description may be similar to descriptions provided by web services, allowing the SCIL system and, in some instances, technical developers associated with the SCIL system, to identify the appropriate connections and technical functionality to use during implementation of the business process. The service contract interface can provide a specific lean interface to the data elements and information provided by the business process for external operations. At 225, the defined business process can optionally be associated with a composite application, where two or more business processes (e.g., newly defined in other instances of method 200, or available from a related application or environment) can be combined to perform further and, in some cases, related functionality.

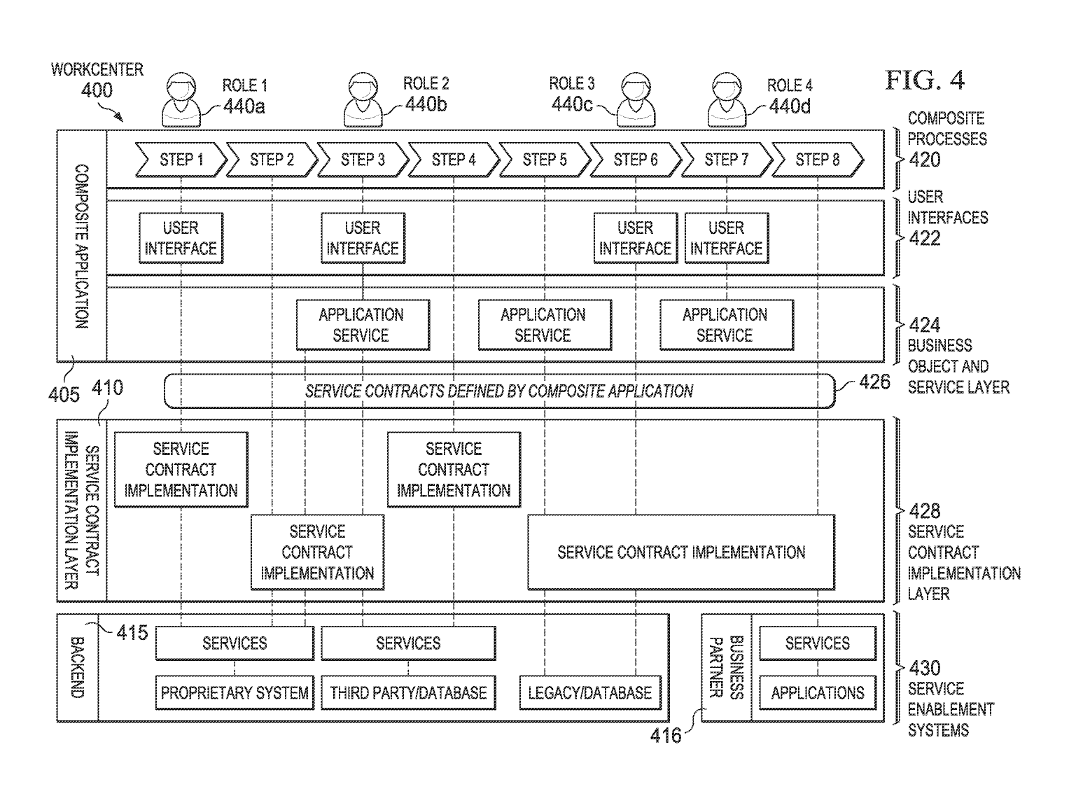

FIG. 3 is a flowchart of an example method 300 for implementing a particular business process through the operations of a SCIL system as described in the present application. For clarity of presentation, the description that follows generally describes method 300 in the context of environment 100 illustrated in FIG. 1. However, it will be understood that method 300 may be performed, for example, by any other suitable system, environment, or combination of systems and environments, as appropriate.

At 305, a business process to be implemented in a particular IT landscape is identified. In some instances, the identified business process may be a business process defined as described in method 200. In general, the business process will be defined and created in an IT landscape-independent methodology, with a focus being placed on the particular business functionality that the business process is to perform. In some instances, the particular IT landscape in which the identified business process is being implemented may be unknown to the developer(s) of the business process. The present solution can still provide a successful implementation of the business process, as the SCIL system associated with the particular implementation can be used to identify the appropriate technical and/or integration processes for providing the functionality needed by the business process. In some instances, the identified business process can be part of the functionality included in a composite application. In some instances, the operations of method 300 can be performed sequentially or concurrently on a plurality of business processes included in the composite application.

At 310, the service contract(s) associated with the business process is identified. In some instances, the service contract(s) can be embedded within the business process, or included in an associated or related file. Each service contract, as previously described, can include a service contract interface and a functionality description. The service contract(s) can be used by the SCIL system to identify one or more technical processes, integration services, or backend applications that perform the business operations required to implement the business process.

At 315, the business process service contract is matched, or linked, to one or more technical services, integration processes, or backend applications associated with the SCIL system, the linked service/integration process capable of performing the required operations needed to implement the business process. The SCIL system, based on its knowledge of available services, integration processes, and backend applications, can identify those which perform the functionality needed to implement the business process in the present IT landscape. In some instances, the SCIL system can query a local database or index of possible services to implement, while in other instances, the SCIL system can search one or more external databases, indices, and/or search engines to identify suitable solutions (i.e., services or applications) for performing the implementation. The criteria for these searches can, in some instances, be based on the information including in and/or derived from one or both of the service contract interface and the functionality description. In some instances, the functionality description may be provided, at least in part, in natural language, while in other instances, at least a part of the functionality description can include standardized portions that can be parsed and interpreted easily by the SCIL system, such as WSDL.

In some instances, the SCIL system may prefer, where available, to delegate calls from the business process to backend applications. When no backend applications are available to perform the required operations, the SCIL system can implement them using one or more local integration services, for example. If a part of the required functionality of the business process is covered by standard business functionality residing in one or more backend systems, the SCIL system can delegate the call to the backend system(s) and their corresponding backend applications and/or backend application data, and subsequently implement the missing functionality within the SCIL system. In other words, the SCIL system is responsible for fully implementing the service contract of the business process.

At 320, connections between the business process and at least one identified service or technical process (from 315) can be implemented to allow the business process to be executable within the current IT landscape. In some instances, the connections may include multiple processes, services, or backend applications working together to perform the required functionality, such as when no single service provides the appropriate functionality required by the business process. In some instances, the connections can be wired together using an appropriate middleware product, such as an integration manager or an Enterprise Service Bus (ESB), capable of identifying and implementing the connections between the business process and the business functionality of the backend applications and/or services. Execution of the business process (or composite application) can be performed, with the business process steps associated with external calls having corresponding messages or events being sent to the SCIL system for execution. The SCIL system can interpret the messages or events, identify the implemented connections, and relay the communications, where appropriate. Responsive communications can be received by the SCIL and provided back to the appropriate service contract interface of the business process. In preferred uses, synchronous communications between the business process, SCIL system, and backend systems can be used for calls performed in response to or for steps providing GUIs, while asynchronous communications between those elements can be used for background calls to services, where appropriate. In some instances, the backend applications, services, and other existing system components may not provide the entire set of functionality required to implement the particular business process. In those instances, the SCIL system can identify the missing functionality, and, where appropriate, provide an implementation of that functionality, as needed. The missing functionality can be programmed within the SCIL system, in some instances, manually, using code programmed in Java™ or any other suitable programming language, including C, C#, or others. Scripting languages could also be used, where appropriate. Generally, the missing functionality can be provided in any appropriate computer language including C, C++, Java™, Visual Basic, ABAP, assembler, Perl®, any suitable version of 4GL, as well as others.

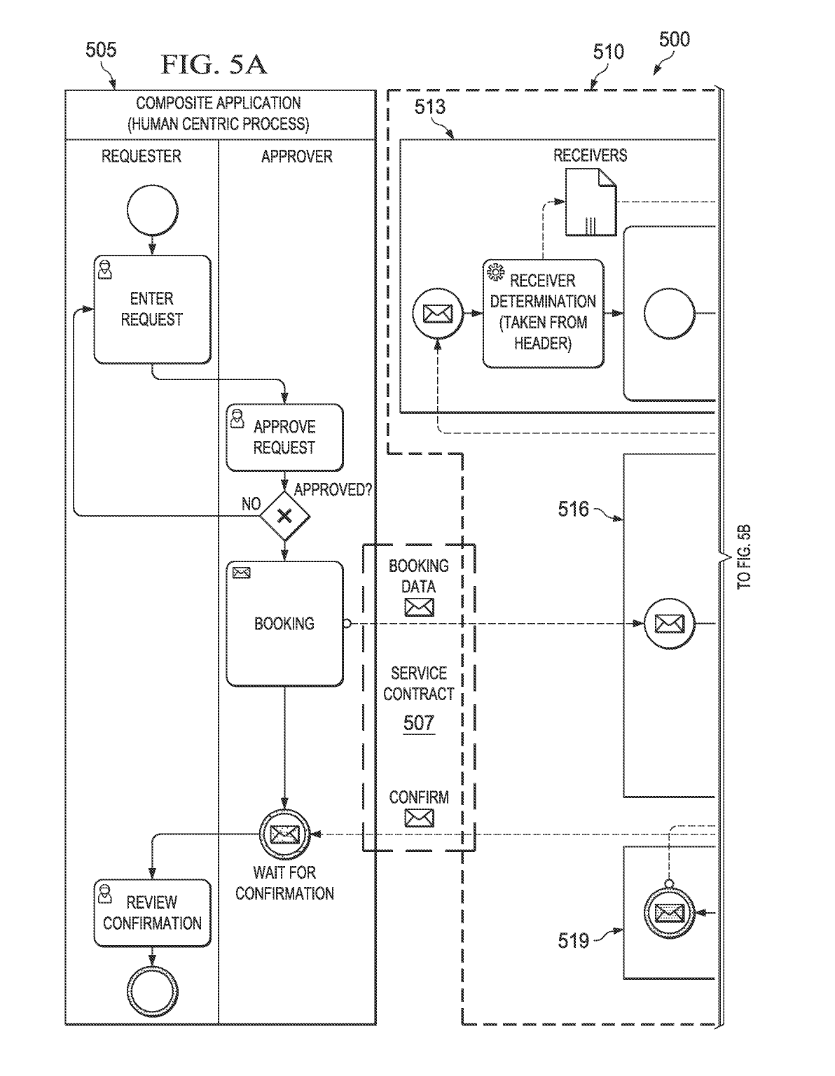

FIG. 4 is an example illustration of a generic system 400 where a composite application is implemented in an example IT landscape through use of the SCIL system. The generic system 400 includes a composite application 405, an SCIL system 410, backend systems 415, and a business partner system(s) 416. The business partner system 416 may be similar to the backend system 415, but may be a system operated by a business partner of the entity implementing the composite application 405.

As illustrated, the composite application 405 includes a series of process steps (illustrated in the composite processes layer 420). The process steps may represent the steps of one or more business processes, where the business processes have been combined to form the composite application 405, and further represent the business functionality performed by the composite application 405. Various steps may include or require input from users associated with particular roles 440a-d, and may be associated with particular user interfaces (as illustrated in the user interface layer 422). Those UIs may be presented to the users associated with the corresponding roles 440, using the receiving input to perform one or more operations. In some instances, the UIs can be presented within the workcenter or application workspace of the users corresponding to those roles. Still further, the composite application 405 includes one or more application services (illustrated in the business object and service layer 424) that perform operations internal to the composite application 405. In some instances, the composite application 405 and its various steps may not need to correspond with external systems, and can provide the functionality in this layer 424. In some instances, these application services may be methods within particular business objects (or other data objects) associated with the composite application 405, as well as functionality previously generated or otherwise locally available within a system associated with the composite application 405.

As previously described, the various business processes included within the composite application 405 are associated with service contracts (illustrated in this example at 426) defining interfaces to the particular steps or operations within the corresponding business process and composite application 405. The SCIL system 410 identifies and interprets those service contracts to identify corresponding business functionality available in one or more service enablement systems 430, including the backend system(s) 415 and the business partner systems 416. The SCIL system 410 can identify and implement a service contract implementation (as illustrated in the service contract implementation layer 428) using a technical implementation process, where the connections and wiring to the one or more external services and/or backend applications are maintained. The SCIL system 410 can act as a router of requests to the appropriate backend and/or partner systems 415, 416, as the composite application 405 and its process steps send messages and events to the SCIL system 410, where the SCIL system 410 then forwards those messages to the corresponding backend services/applications. Alternatively, the SCIL system 410 can develop local functionality for implementing the needed business functionality when the business functionality is not available in existing systems. The backend and partner services can access and process corresponding backend data in light of their received responses, and can provide responsive messages back to the SCIL system 410, which can in turn return those responsive messages to the appropriate process steps of the composite application 405. In general, the functionality of the backend and partner services can be accessed through standard interfaces (e.g., web services, APIs, etc.) or other proprietary interfaces. In the illustrated example, the services labeled “services” represent standard interfaces, while the “legacy” systems may use proprietary interfaces. The SCIL system 410 can generally interact with these standard and proprietary interfaces, as needed.

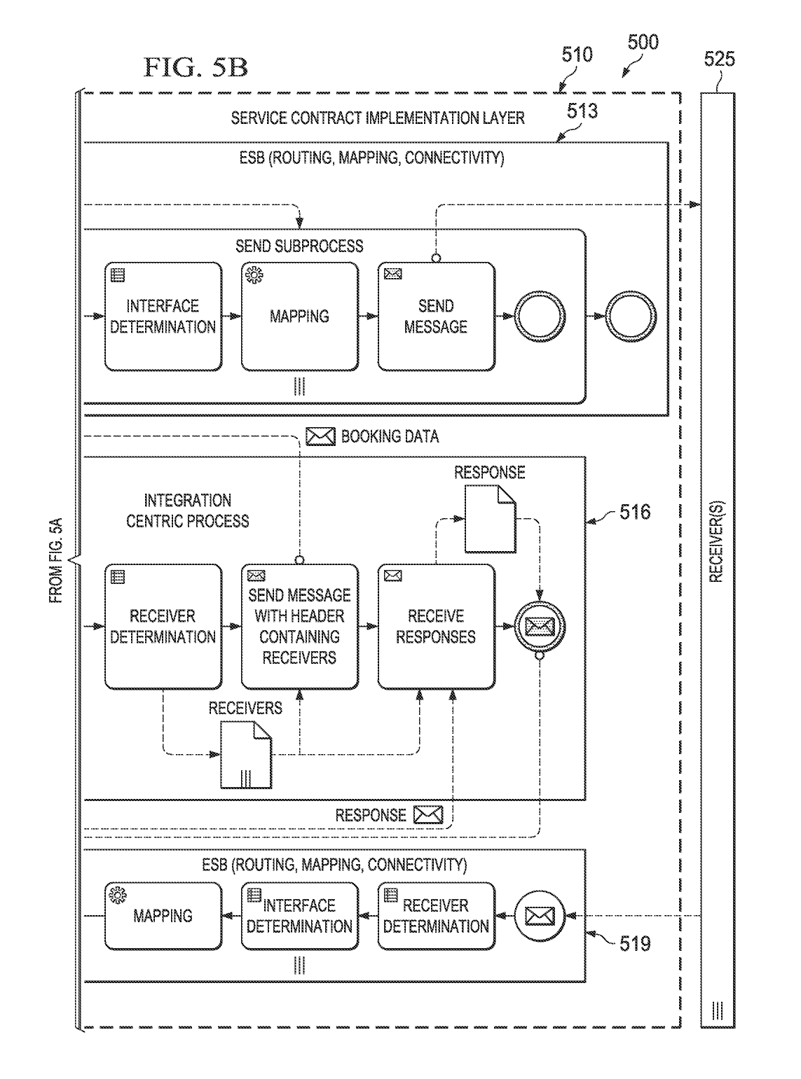

FIG. 5 illustrates an example implementation 500 of a composite application implemented an example IT landscape. As illustrated, the implementation 500 includes the composite application 505, the service contract implementation layer (SCIL) 510, and one or more receivers 525 (or backend systems). The composite application 505 and the implemented technical processes within the SCIL 510 are each modeled using BPMN, and illustrate the process steps associated with each respective process. The composite application 505 is associated with a service contract 507 that defines the data elements to be sent from the particular steps of the composite application 505, as well as the data to be returned to the particular steps of the composite application 505.

In the illustrated example, the SCIL 510 has already identified an appropriate set of integration, or technical, processes to fulfill the requirements identified by the service contract 507. Specifically, the data elements and functionality required by the “booking” process step and corresponding “wait for confirmation” process step, as defined by the service contract 507, are fulfilled by a combination of a stateful process 516 and its associated stateless processes 513 and 519. Process 516, labeled “integration centric process,” comprises a stateful process directly associated with, or wired to, the composite application 505. This process 516 receives the outgoing message or event from the “booking” step and returns an incoming message or event back to the “wait for confirmation” intermediate event, as illustrated in the BPMN models. In the present example, process 516 is unable to perform the complete task required by the service contract 507, and therefore uses the two supplementary and stateless processes 513 and 519 to complete the operations. Both processes 513 and 519 interact with the receiver(s) 525 to employ the receivers' operations and backend data. Process 513 sends appropriate messages to the receivers 525, and process 519 receives the respective response messages from the receivers 525. The responsive information is passed back to process 516, which then returns a set of data associated with those responses to the “wait for confirmation” process step.

In this example, the particular processes 513, 516, 519 used to implement the service contract 507 were based on the SCIL's determination that these processes were the best fit for the available IT infrastructure. In alternative implementations, such as those in different IT landscapes, a single process could be used to implement the service contract 507. Additionally, any alternative processes, or combinations of processes, could be used to fulfill the requirements specified by the service contract 507. The respective SCIL 510 would implement any suitable combination of processes capable of fulfilling the requirements. In some instances, a set of rules or priorities associated with the respective SCILs 510 could change how particular implementations are implemented. For example, some SCILs 510 may have rules in place to provide the fewest number of technical processes into the implementation, while in others, alternative priority rules may change the particular implementation identified by the SCIL 510. In this manner, the same composite application 505 can be added to and implemented in various IT landscapes without requiring the composite application 505 being dependent on particular technologies or particular IT landscapes.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method performed by one or more processors for providing a process-driven composite application architecture, the method comprising:
identifying a business process for implementation in an information technology (IT) landscape;
identifying a service contract associated with the identified business process, the service contract defining business functionality required for implementation in the IT landscape;
identifying at least one technical process for implementing the business functionality defined by the service contract; and
implementing the identified business process in the IT landscape, where implementing the identified business process includes implementing a connection between the identified business process and the identified at least one technical process.

2. The method of claim 1, wherein the business process and the at least one technical process are modeled in business process model and notation (BPMN).

3. The method of claim 1, wherein the service contract includes a service contract interface and a functionality description of the business process.

4. The method of claim 3, wherein the service contract interface includes a web services description language (WSDL) description.

5. The method of claim 3, wherein the functionality description of the business process includes a natural language description of the business process.

6. The method of claim 5, wherein the functionality description of the business process includes a description of at least one input or output required for implementation of the business process.

7. The method of claim 1, wherein the business process comprises a business process defined independent of a particular IT landscape.

8. The method of claim 1, wherein the connection between the identified business process and the identified at least one technical process comprises an implementation of the service contract in a service contract implementation layer.

9. The method of claim 1, wherein the at least one technical process includes at least one of a web service, an application associated with a backend system, or an integration process.

10. The method of claim 1, wherein the identified business process is incorporated into a composite application, the composite application including two or more business processes.

11. The method of claim 10, wherein identifying the business process includes defining the business process, and wherein defining the business process includes:
defining a set of business process steps associated with the operations of the business process;
identifying at least one data object associated with the business process;
identifying a set of previously unavailable business functionality to be implemented as part of the composite application; and
defining a particular service contract associated with the business process, the service contract including at least a service contract interface.

12. A computer program product for providing a process-driven composite application architecture, the computer program product comprising computer readable instructions embodied on tangible, non-transitory media, the instructions operable when executed to:
identify a business process for implementation in an information technology (IT) landscape;
identify a service contract associated with the identified business process, the service contract defining business functionality required for implementation in the IT landscape;
identify at least one technical process for implementing the business functionality defined by the service contract; and
implement the identified business process in the IT landscape, where implementing the identified business process includes implementing a connection between the identified business process and the identified at least one technical process.

13. The product of claim 12, wherein the business process and the at least one technical process are modeled in business process model and notation (BPMN).

14. The product of claim 12, wherein the service contract includes a service contract interface and a functionality description of the business process.

15. The product of claim 14, wherein the service contract interface includes a web services description language (WSDL) description.

16. The product of claim 14, wherein the functionality description of the business process includes a natural language description of the business process.

17. The product of claim 12, wherein the business process comprises a business process defined independent of a particular IT landscape.

18. The product of claim 12, wherein the connection between the identified business process and the identified at least one technical process comprises an implementation of the service contract in a service contract implementation layer.

19. The product of claim 12, wherein the identified business process is incorporated into a composite application, the composite application including two or more business processes.

20. The product of claim 19, wherein identifying the business process includes defining the business process, and wherein defining the business process includes:
defining a set of business process steps associated with the operations of the business process;
identifying at least one data object associated with the business process;
identifying a set of previously unavailable business functionality to be implemented as part of the composite application; and
defining a particular service contract associated with the business process, the service contract including at least a service contract interface.

21. A system comprising:
one or more computers; and
a computer-readable medium coupled to the one or more computers having instructions stored thereon which, when executed by the one or more computers, cause the one or more computers to perform operations comprising:
identifying a business process for implementation in an information technology (IT) landscape;
identifying a service contract associated with the identified business process, the service contract defining business functionality required for implementation in the IT landscape;
identifying at least one technical process for implementing the business functionality defined by the service contract; and
implementing the identified business process in the IT landscape, where implementing the identified business process includes implementing a connection between the identified business process and the identified at least one technical process.
